(19) United States
(12) Patent Application Publication
(10) Pub. No.: US 2007/0021919 A1
(43) Pub. Date: Jan. 25, 2007

(54) Silico design of chemical arrays

(76) Inventors: Eric M. Leproust, San Jose, CA (US); Michael G. Booth, Boulder Creek, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/185,207

(22) Filed: Jul. 19, 2005

(51) Int. Cl. G06F 19/00

(52) U.S. Cl. 702/19; 702/20

(57) ABSTRACT

A system is described which comprises an input manager for receiving probe request information from a probe requester and a processing module configured to identify a probe sequence associated with the probe request information, wherein the processing module associates a flag with one or more nucleic acid sequences corresponding to the probe request associated with a predefined sequence characteristic. Methods of using the system and computer program products for implementing the methods are also described.

### BACKGROUND

Nucleic acids (DNA and RNA) can be synthesized chemically or enzymatically. Chemical synthesis of nucleic acids can be achieved without a template, i.e., with only the in silico knowledge of the sequence, but the length of the synthesized fragments in practice is limited to about 100 to 200 base pairs due to side reactions (e.g., depurination, branching, etc.) and coupling efficiencies less than 100%. In addition, the end product is a mixture of the intended sequence and of sequences with multiple random deletions. On the other hand, enzymatic synthesis allows generation of long fragments (more than 1000 bases) but requires a template of the sequence to reproduce. The purity is usually high and errors are typically mutations due to the incorporation of the wrong base by the enzyme(s) used.

Recently, considerable interest has been shown in achieving the synthesis of long pieces of nucleic acids without the use of a template, such as in gene synthesis applications. This approach offers the advantages of both chemical and enzymatic synthesis, without the drawbacks of both. For example, Cello, et al., Science 2002; 297:1016-18, report that they were able to synthesize long parts of the polio virus without physical access to the natural template, i.e., solely from electronic sequence information and commercially available DNA oligonucleotides. More recently, Church, et al., Nature 2004; 432: 1050-54, have shown that such gene synthesis was indeed possible using nucleic acids manufactured on a microarray platform.

Cleaving oligonucleotide probes off of an array substrate may facilitate gene synthesis. However, in certain cases, it may be desirable to control the applications to which an array platform is put and to limit the use of an array in gene synthesis reactions. For example, in certain instances, a supplier may desire to provide an array for limited use in particular applications (e.g., such as in diagnostic assays) for which the supplier may be able to provide quality assurances.

### SUMMARY OF THE INVENTION

In one embodiment, the invention relates to a system comprising an input manager for receiving probe request information from a probe requester, and a processing module configured to identify a probe sequence associated with the probe request information, wherein the processing module associates a flag with one or more nucleic acid sequences corresponding to the probe request associated with a predefined sequence characteristic. A predefined sequence characteristic can include, but is not limited to: a cleavage site (e.g., such as a restriction enzyme site), a sequence forming secondary structure, a sequence providing a recognition site for a recombinase, a palindromic sequence, a predefined primer binding site, a sequence type repeated in other probes being requested by the user, a vector sequence, a sequence with a predefined level of homology to a predefined sequence (e.g., such as a sequence found in a pathogenic organism), complementary sequences within a probe (e.g., a 3′ terminal sequence complementary to a 5′ terminal sequence), and combinations thereof. In certain aspects, a first probe request sequence is compared to a second probe request sequence and the predefined sequence characteristic comprises a relationship between the first and second probe request sequence (e.g., such as complementarity, shared restriction cleavage sites, and/or a common origin from the same pathogenic organism).

In one aspect, the system provides a notice to a probe reviewer that a flag has been associated with a probe request. In another aspect, the notice also is sent to the probe requester. In certain aspects, the notice includes a request for further information about the probe request. In one aspect, the notice indicates a probe request status such as: on hold; not approved; subject to approval pending receipt of information; or subject to approval subject to limitations (e.g., such as acceptance of certain contract terms or restrictions on use). In certain aspects, notice further includes a description of a reason for the hold. In certain aspects, notice is only provided to the probe requester if the probe reviewer does not approve of the probe request. However, in other aspects, notice is provided either by itself, or along with a request that further information be provided to a designated contact (who may be the probe reviewer or another user designated to the system).

In another embodiment, the system further comprises an output manager for providing probe content information to the probe reviewer and/or probe requester. In one aspect, the output manager further includes a communication module for communicating the probe content information to a vendor and/or manufacturer of nucleic acid sequences and/or arrays.

In certain aspects, the probe request includes selection criterium for identifying a probe. For example, the probe request can include, without limitation, information such as a sequence, a sequence identifier, an accession number, an exon identifier; a chromosomal location, information relating to an annotation category and combinations thereof. In one aspect, in response to received selection criterium, the output manager displays a probe group comprising probe content information for one or more probes. In certain aspects, display of probe group members is restricted. For example, the output manager may display a probe group to the probe requester that does not include probe content information for a flagged probe sequence, while displaying probe content for all probe group members to a reviewer. However, in other aspects, the displayed probe content information displayed to a probe requester includes content information for both flagged and unflagged probe sequences.

In one embodiment, a displayed member of the probe group is associated with a means for selecting the member for ordering (e.g., such as a check box, radio button or other link) and in response to selecting, a notice is sent to a user of the system that the member of the probe group has been ordered. In certain aspects, a displayed member of the probe group is selected for inclusion in an array. In one aspect, only members of a probe group that are not associated with a flag are associated with an active means for selecting the members for ordering. In further aspects, one or more probe request sequences selected for ordering are associated with a customer identifier and/or purchase order identifier (e.g., in a memory of the system).

In one embodiment, a flag can be removed from a probe member by a probe reviewer. Additionally or alternatively, a probe group displayed to the probe requester is modifiable by a probe reviewer.

In another embodiment, the system comprises or can access a memory comprising a database of sequences having the predefined sequence characteristic. In one aspect, the system further comprises a search engine for comparing probe request information to data in the memory. In one aspect, the processing module determines whether a sequence being requested has a predefined threshold identity to a sequence having the predefined characteristic and associates a flag with the sequence being requested when the predefined threshold is met. In another aspect, the system adds a sequence corresponding to the probe request to the database for comparison with one or more subsequent probe request sequences.

In certain aspects, the system may provide an output to the probe requester, inviting the probe requester to withdraw or modify the probe request. In certain aspects, the system will not accept further requests from a probe requester unless the probe requester withdraws or modifies the probe request and/or acknowledges the probe request status (e.g., acknowledging that the probe requestor will contact a probe reviewer or other designated contact for the probe request).

In one aspect, when a probe request sequence is associated with a flag, the system provides an output to the probe requester identifying one or more alternative probe sequences that would not be associated with a flag. In another aspect, the system additionally outputs data relating to a property (e.g., such as Tₘ, etc.) of the one or more alternative probe sequences. In a further aspect, where a set of probe sequences has received a flag, the probe requester is provided with the option to remove and/or modify one or more members of the set.

In still a further aspect, if a probe request with a flag is approved (e.g., by the probe reviewer), the system's output manager communicates the probe request in the form of an order to synthesize or supply the probe. In certain aspects, the order includes instructions to include the probe on an array.

In certain embodiments, the system generates and maintains an audit trail relating to changes in the status of a probe request (e.g., such as a change from a hold to approval, or a change which removes or modifies a probe member of a probe group). The audit trail can include such information as the date the status changed and the name of the user who changed the status.

The system can display additional options to allow a user such as a probe requestor to develop probe sets which include one or more requested probes. In certain aspects, the system includes an array layout developer to facilitate design and/or selection of an array layout that includes the one or more requested probes.

In another embodiment, the system further comprises a collaboration manager configured to all at least two different probe requesters to jointly provide probe request information and/or array request information to the system.

In still another embodiment, the system further comprises a security manager configured to control information transfer in a predetermined manner between at least two different users or groups of users of the system.

The invention also relates to computer readable storage medium having a computer program stored thereon for implementing one or more operations of the system. In one aspect, the computer program, when loaded onto a computer operates the same or a different computer to receive probe request information and determine whether a flag should be associated with the requested probe.

The invention further relates to methods for using the system. In one embodiment, a method according to the invention comprises receiving probe request information, identifying a probe sequence associated with the probe request information, and associating a flag with a sequence corresponding the probe request when the sequence is associated with a predefined sequence characteristic as discussed above. In one aspect, notice is provided to a probe reviewer that a flag is associated with a sequence corresponding to the probe request. In one aspect, the notice is sent to a probe requester who has provided the probe request information. In another aspect, the notice indicates that a probe request has received a status, such as: on hold; not approved; subject to approval pending receipt of information; and subject to approval subject to limitations (e.g., agreement to certain contact terms or limitations on use). In another aspect, the notice includes a request for further information about the probe request. In certain aspects, the notice includes a description of the reason for the flag.

In certain aspects, the flag is removed from the sequence corresponding to the probe request (e.g., by a reviewer of the probe request), for example, after receiving further information from the probe requester.

In certain aspects, a probe requester is invited to withdraw or modify a probe request when it is associated with a flag.

In one aspect, the method further comprises providing an order for a nucleic acid comprising the sequence or for an array including the sequence to a vendor and/or manufacture of nucleic acid sequences and/or arrays.

In one embodiment, the probe request includes selection criterium for identifying a probe, such as for example, sequence information, a sequence identifier, an accession number, an exon identifier; a chromosomal location, information relating to an annotation category and combinations thereof. In certain aspects, in response to the selection criterium, a probe requester is provided with probe content information for one or more probes in a probe group. In certain aspects, the probe content information provided to a probe requester does not include probe content information for a flagged probe sequence, while the probe content information provided to a probe reviewer does include probe content information for a flagged probe sequence. However, in certain aspects, the probe content information provided to the probe requester does include probe content information for a flagged probe sequence.

In one aspect, the probe requester is provided with a means for selecting a member of the probe group for ordering. In some aspects, a notice is sent (e.g., to a vendor and/or manufacturer) if a member of the probe group is ordered. In certain aspects, a probe requester cannot select a member of a probe group for ordering if the member is associated with a flag.

In certain aspects, a probe reviewer modifies probe information content for one or more members of the probe group.

In certain aspects, a sequence corresponding the probe request is compared to a database comprising sequence(s) having the predefined sequence characteristic. In one aspect, a method according to an embodiment of the invention further comprises determining whether a sequence corresponding to the probe request has a predefined threshold identity to a sequence having the predefined characteristic and associating a flag with the sequence when the predefined threshold is met.

In one aspect, when a probe request sequence is associated with a flag, an output is provided to the probe requester identifying one or more alternative probe sequences that would not be associated with a data flag. The output may include data relating to a property of the one or more alternative probe sequences. In another aspect, if the probe reviewer approves the probe request, an order is sent to a vendor and/or manufacturer of nucleic acid sequences and/or arrays to synthesize or supply the probe (and/or an array substrate on which the probe might be included). In certain aspects, the method further comprises designing an array layout or selecting an array layout for an array that includes the probe.

### DESCRIPTION OF THE INVENTION

Before describing the present invention in detail, it is to be understood that this invention is not limited to specific compositions, method steps, or equipment, as such may vary. It is also to be understood that the terminology used herein is for the purpose of describing particular embodiments only, and is not intended to be limiting. Methods recited herein may be carried out in any order of the recited events that is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

Unless defined otherwise below, all technical and scientific terms used herein have the same meaning as commonly understood by one of ordinary skill in the art to which this invention belongs. Still, certain elements are defined herein for the sake of clarity.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

It must be noted that, as used in this specification and the appended claims, the singular forms “a”, “an” and “the” include plural referents unless the context clearly dictates otherwise. Thus, for example, reference to “a biopolymer” includes more than one biopolymer and the like.

The term “array layout” refers to collection of information, e.g., in the form of a file or a graphical representation, which represents the location of probes that have been assigned to specific features of an array format.

The phrase “array format” refers to a format that defines an array by feature number, feature size, Cartesian coordinates of each feature, and distance that exists between features within a given array.

The phrase “array request information” is used broadly to encompass any type of information/data that is employed in developing an array layout, where representative types of array request information include, but are not limited to: probe content identifiers, e.g., in the form of probe sequence, gene name, accession number, annotation, etc.; array function information, e.g., in the form of types of genes to be studied using the array, such as genes from a specific species (e.g., mouse, human), genes associated with specific tissues (e.g., liver, brain, cardiac), genes associated with specific physiological functions, (e.g., apoptosis, stress response), genes associated with disease states (e.g., cancer, cardiovascular disease), etc.; array format information, e.g., feature number, feature size, Cartesian coordinates of each feature, and distance that exists between features within a given array; etc.

A “data element” represents a property of a probe sequence, which can include the base composition of the probe sequence. Data elements can also include representations of other properties of probe sequences, such as expression levels in one or more tissues, interactions between a sequence (and/or its encoded products), and other molecules, a representation of copy number, a representation of the relationship between its activity (or lack thereof) in a cellular pathway (e.g., a signaling pathway) and a physiological response, sequence similarity to other probe sequences, a representation of its function, a representation of its modified, processed, and/or variant forms, a representation of splice variants, the locations of introns and exons, functional domains, etc. A data element can be represented, for example, by an alphanumeric string (e.g., representing bases), by a number, by “plus” and “minus” symbols or other symbols, by a color hue, by a word, or by another form (descriptive or nondescriptive) suitable for computation, analysis and/or processing, for example, by a computer or other machine or system capable of data integration and analysis.

As used herein, the term “data structure” is intended to mean an organization of information, such as a physical or logical relationship among data elements, designed to support specific data manipulation functions, such as an algorithm. The term can include, for example, a list or other collection type of data elements that can be added, subtracted, combined or otherwise manipulated. Exemplarily, types of data structures include a list, linked-list, doubly linked-list, indexed list, table, matrix, queue, stack, heap, dictionary, flat file databases, relational databases, local databases, distributed databases, thin client databases and tree. The term also can include organizational structures of information that relate or correlate, for example, data elements from a plurality of data structures or other forms of data management structures. A specific example of information organized by a data structure of the invention is the association of a plurality of data elements relating to a gene, e.g., its sequence, expression level in one or more tissues, copy number, activity states (e.g., active or non-active in one or more tissues), its modified, processed and/or variant forms, splice variants encoded by the gene, the locations of introns and exons, functional domains, interactions with other molecules, function, sequence similarity to other probe sequences, etc. A data structure can be a recorded form of information (such as a list) or can contain additional information (e.g., annotations) regarding the information contained therein. A data structure can include pointers or links to resources external to the data structure (e.g., such as external databases). In one aspect, a data structure is embodied in a tangible form, e.g., is stored or represented in a tangible medium (such as a computer readable medium).

The term “object” refers to a unique concrete instance of an abstract data type, a class (that is, a conceptual structure including both data and the methods to access it) whose identity is separate from that of other objects, although it can “communicate” with them via messages. In some occasions, some objects can be conceived of as a subprogram which can communicate with others by receiving or giving instructions based on its, or the others' data or methods. Data can consist of numbers, literal strings, variables, references, etc. In addition to data, an object can include methods for manipulating data. In certain instances, an object may be viewed as a region of storage. In the present invention, an object typically includes a plurality of data elements and methods for manipulating such data elements.

A “relation” or “relationship” is an interaction between multiple data elements and/or data structures and/or objects. A list of properties may be attached to a relation. Such properties may include name, type, location, etc. A relation may be expressed as a link in a network diagram. Each data element may play a specific “role” in a relation.

As used herein, an “annotation” is a comment, explanation, note, link, or metadata about a data element, data structure or object, or a collection thereof. Annotations may include pointers to external objects or external data. An annotation may optionally include information about an author who created or modified the annotation, as well as information about when that creation or modification occurred. In one embodiment, a memory comprising a plurality of data structures organized by annotation category provides a database through which information from multiple databases, public or private, may be accessed, assembled, and processed. Annotation tools include, but are not limited to, software such as BioFerret (available from Agilent Technologies, Inc., Palo Alto, Calif.), which is described in detail in application Ser. No. 10/033,823 filed Dec. 19, 2001 and titled “Domain-Specific Knowledge-Based Metasearch System and Methods of Using.” Such tools may be used to generate a list of associations between genes from scientific literature and patent publications.

As used herein an “annotation category” is a human readable string to annotate the logical type the object comprising its plurality of data elements represents. Data structures that contain the same types and instances of data elements may be assigned identical annotations, while data structures that contain different types and instances of data elements may be assigned different annotations.

As used herein, a “probe sequence identifier” or an “identifier corresponding to a probe sequence” refers to a string of one or more characters (e.g., alphanumeric characters), symbols, images or other graphical representation(s) associated with a probe comprising a probe sequence such that the identifier provides a “shorthand” designation for the sequence. In one aspect, an identifier comprises an accession number or a clone number. An identifier may comprise descriptive information. For example, an identifier may include a reference citation or a portion thereof. In this manner, the identifier corresponds to the probe and sequence thereof.

As used herein “probe request information” refers to any type of information that is employed to obtain one or more probes, and may comprise one or more search terms, key words, accession numbers, or probe sequences. Probe request information may take a number of different forms, such as sequence information, location identifier information, art accepted identifier, e.g., accession no, information, etc.

The phrase “best-fit” refers to a resource allocation scheme that determines the best result in response to input data. The definition of ‘best’ may vary depending on a given set of predetermined parameters, such as sequence identity limits, signal intensity limits, cross-hybridization limits, Tm, base composition limits, probe length limits, distribution of bases along the length of the probe, distribution of nucleation points along the length of the probe (e.g., regions of the probe likely to participate in hybridization, secondary structure parameters, etc. In one aspect, the system considers predefined thresholds. In another aspect, the system rank-orders fit. In a further aspect, the user defines his or her own thresholds, which may or may not include system-defined threshold. In certain cases, the system excludes probes from a ranking that would otherwise be associated with a data flag. In still another aspect, the system assigns a lower rank to probes that are associated with a data flag and, in certain aspects, can re-rank probes when data flags are removed.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

A “biopolymer” is a polymer of one or more types of repeating units. Biopolymers are typically found in biological systems (although they may be made synthetically) and may include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a “biopolymer” may include DNA (including cDNA), RNA, oligonucleotides, and PNA and other polynucleotides as described in U.S. Pat. No. 5,948,902 and references cited therein (all of which are incorporated herein by reference), regardless of the source.

A “biomonomer” references a single unit, which can be linked with the same or other biomonomers to form a biopolymer (e.g., a single amino acid or nucleotide with two linking groups, one or both of which may have removable protecting groups).

An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), etc.) associated with that region. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus).

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm2 or even less than 10 cm2. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

An “array layout” refers to a collection of information, e.g., in the form of a file, that represents the location of probes that have been assigned to specific features of an array format. The phrase “array format” refers to a format that defines an array by feature number, feature size, Cartesian coordinates of each feature, and distance that exists between features within a given array.

The phrase “array request information” is use broadly to encompass any type of information/data that is employed in developing an array layout, where representative types of array request information include, but are not limited to: probe request information, including, but not limited to: probe content identifiers, e.g., in the form of probe sequence, gene name, accession number, annotation, etc.; array function information, e.g., in the form of types of genes to be studied using the array, such as genes from a specific species (e.g., mouse, human), genes associated with specific tissues (e.g., liver, brain, cardiac), genes associated with specific physiological functions, (e.g., apoptosis, stress response), genes associated with disease states (e.g., cancer, cardiovascular disease), etc.; array format information, e.g., feature number, feature size, Cartesian coordinates of each feature, and distance that exists between features within a given array; etc.

The term “high-resolution probe” refers to one or more probes that elucidate small differences between populations and/or treatment groups in microarray experiments in comparison to a “low-resolution probe” to that elucidates large differences between populations and/or treatment groups in microarray experiments. In another aspect, a “high-resolution probe” refers to a probe that can be used to scan smaller regions of a genome relative to a low-resolution probe, which can be used to scan larger regions of a genome.

The term “normalization probe” refers to probes that have been empirically proven to show constant signal intensities, and can be used to normalize microarray data results. In these embodiments, a user may input probe request information, in response to which the probe developer may, in addition to providing a probe based on the request information, suggest to the user one or more normalization probes to use with the provided probe. In addition, the User can define the target intensity values of the Normalization probes, and/or define a profile of a normalization probe set, where the profiles contain target intensity values that the normalization probes should exhibit. In addition, the User can define a range of specificity for the probe intensity values.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

“Hybridizing” and “binding”, with respect to polynucleotides, are used interchangeably.

The term “substrate” as used herein refers to a surface upon which marker molecules or probes, e.g., an array, may be adhered. Glass slides are the most common substrate for biochips, although fused silica, silicon, plastic and other materials are also suitable. When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information references transmitting the data representing that information as signals (e.g., electrical, optical, radio signals, etc.) over a suitable communication channel (e.g., a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that many computer-based systems are available which are suitable for use in the present invention. The data storage means may comprise any manufacture comprising a recording of the present information as described above, or a memory access means that can access such a manufacture.

A “processor” references any hardware and/or software combination, which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

Items of data are “linked” to one another in a memory when the same data input (for example, filename or directory name or search term) retrieves the linked items (in a same file or not) or an input of one or more of the linked items retrieves one or more of the others.

In one embodiment, the invention provides systems and methods for using the same to obtain one or more probe sequences, e.g., for use on an array. Embodiments of the invention include a system for determining at least one probe sequence, where the system includes: an input manager receiving probe request information from a user; a processing module that is configured to identify a probe sequence, and an output manager for providing probe content information that includes the at least one probe sequence or an identifier of the at least one probe sequence to the user. In certain aspects, the output manager further includes a communication module for communicating the probe content information to a manufacturer and/or vendor. The system can also comprise a memory including probe sequence information. For example, in one aspect, the memory comprises a plurality of objects comprising a plurality of data elements including probe sequence information. Additionally, the processor, in certain aspects, may identify a probe sequence that best fits a user request based on information regarding attributes of a plurality of data structures, e.g., the processor may identify a probe suitable for use under certain hybridization conditions.

The system may provide for remote communication between a user and a processing module of the system via the input module. In one aspect, the system includes a graphical user interface (GUI). In another aspect, the system provides for communication between a user and the processing module via the Internet.

The input manager can receive a user request in a variety of forms. In one aspect, the user request is a form that is built using SQL, HTML or XML statement(s) or is translated to an SQL, HTML, or XML statement. In certain aspects, the input manager enables a permitted user to add data as an object in the memory of the system and in one aspect, the input manager enables a plurality of permitted users to add the data.

In certain aspects, the input manager enables one or more permitted users to add objects to the memory. In certain aspects, the objects are encapsulated.

In one embodiment, a user request includes selection criteria for identifying a probe and the input manager enables a permitted user to add the selection criteria to the memory of the system. In certain embodiments, the input manager enables a plurality of permitted users to add their selection criteria to the memory. Probe request information can include, but is not limited to: a sequence, a sequence identifier, a accession number corresponding to a sequence in a data base, an exon identifier; a chromosomal location; data relating to an annotation category and the like.

The system also can include a memory that comprises data structures representing one or more sequences in one or more external databases and/or can include pointers linking the system to one or more external databases.

Data structures can also include attributes of a probe that include representations of properties of the probe observed during empirical testing. In certain embodiments, attributes include information relating to predicted properties of the probe.

In one aspect, the system, in response to request information, provides to the user one or more of the following: at least one probe sequence that comprises an exon identifier; at least one probe sequence that comprises a chromosomal location; at least one second probe sequence that comprises identifier information for a first probe sequence, wherein said second probe sequence shares sequence identity with said first probe; a probe group of high resolution probe sequences that comprises identifier information for a low resolution probe; validation information for a probe; and a probe set of normalization probes.

In another aspect, the system provides at least one second probe sequence in response to request information that comprises identifier information for a first probe sequence, which shares sequence identity with the first probe. In another aspect, the first probe sequence is from a first species and the second probe sequence is from a second species, where the first and second probe sequences may be homologous, orthologous or paralogous.

In certain aspects, the processing module further includes one or more means to flag probes requests for probes associated with certain characteristics (e.g., such as sequence characteristics). For example such means can include a look-up table, a relational database, and the like. In one aspect, the processing module comprises one or more means for identifying whether a requested probe includes a cleavage site (e.g., such as a restriction enzyme site), a sequence that would promote the formation of secondary structures including such cleavage sites, one or more sequences providing recognition sites for a recombinase, a sequence commonly used to bind to a primer (e.g., a commercially available primer, including but not limited, to a primer comprising a polymerase binding site, a primer for reverse transcription, and the like), the presence of internal complementary sequences, palindromic sequences, and other sequences added to probes for use in a subsequent enzyme-mediated reaction such as an amplification reaction, a ligation reaction, a recombination reaction, etc.

In certain aspects, sets of requested probes are evaluated to identify the presence of restriction sites that are common between members of the set or whose presence in a double-stranded probe would result in ends complementary with another probe member of the set. In other aspects, a set of probes are evaluated to identify the presence of repeating sequences, e.g., at ends of the probes or internally, which might promote the formation of concatamers or intermolecular recombination events. In still other aspects, a probe is evaluated for the presence of vector sequences or complements thereof.

In one embodiment, probe requests are evaluated to determine the homology of a probe sequence to one or more sequences in a memory of the system or in a memory accessible by the system. In certain other embodiments, the processing module further comprises a search engine for comparing probe request information to data in the memory

In certain aspects, the probe requests are evaluated to determine if one or more probe sequences being requested has sequence identity above a predefined threshold to a gene for which approval is required for inclusion on an array. In certain aspects, the predefined threshold is defined by a system administrator (e.g., one or more individuals designated to the system). For example, in one aspect, a system administrator may provide instructions to the system to associate a data flag with probe requests for sequences from a pathogenic organism. In one aspect, the sequence is from a specifically identified gene, e.g., such as a gene encoding a virulence factor, in another aspect, the sequence is any gene sequence that is found in the genome in the pathogenic organism or is a gene that is otherwise associated with pathogenesis.

In a further aspect, although a probe request for a single sequence from a pathogenic organism may not receive a data flag, a request for a plurality of sequences from the pathogenic organism, e.g., for use in construction of a single or multiple arrays can receive a data flag.

In certain aspects, e.g., where the probe request does not include inputted sequence information but comprises an identifier (e.g., such as an accession number), the processing module further comprises a means to identify the sequence corresponding to the identifier. For example, the system may comprise a memory or have access to a memory including a relational database and comprise or communicate with a means for searching such a database. In certain aspects, even when a probe request includes inputted sequence information, the means to identify the sequence may be used to identify a larger sequence (e.g., such as a gene) of which the probe sequence is a subsequence.

In one aspect, the processing module implements one or more algorithms for comparing a sequence corresponding to the probe request (which may inputted in the form of an actual sequence or an identifier of a sequence, e.g., such as an accession number) to a database of sequences comprising a set (e.g., one or more sequences) of unapproved sequences or sequence elements (e.g., one or more of: cleavage sites, sequences for secondary structure, binding sites for primers and recombinases, vector sequences, repetitive sequences, palindromic sequences, complementary sequences, etc.) to determine whether the sequence being requested has more than a predefined threshold identity to the unapproved sequence.

The database can be a dynamic one, with sequences added and/or removed and/or modified by the system administrator or by the system itself (e.g., according to pre-programmed instructions). For example, in one aspect, when a probe request is received, a sequence corresponding to the probe can be added to the database so that further requested probe sequences are compared to one or more previous probe requested sequence(s), e.g., to monitor the presence of repeated or complementary sequences in series of requested probes, to monitor the presence of cleavage sites, binding sites for primers and recombinases, etc. Sequences added to the system database can also be removed from the database, e.g., after a set of probes is evaluated and an order for an array comprising the set is provided to a manufacturer and/or vendor. However, in certain cases, sequences added to the database are retained in the database and may optionally be associated with a customer number, e.g., identifying a user (e.g., such as a customer) making the request.

Algorithms to evaluate sequences are known in the art and include, but are not limited to: a BLAST program, such as BLAST-2 (Altschul, et al. Nucleic Acids Res. 1997; 25:3389-3402); CLUSTAL W (Thompson, et al., Nucleic Acids Research 1994; 22:4673-4680); LALIGN (Huang and Miller, Adv. Appl. Math. 1991; 12:337-357); DCA (Dress, et al., Proceedings of the Third International Conference on Intelligent Systems for Molecular Biology (ISMB 95), AAAI Press, Menlo Park, Calif., USA, 107-113, 1995); DIALIGN2 (Morgenstern, Bioinformatics 1999; 15:211-218), RNAFOLD (Hofacker, et al., Chemie 1994; 125:167-188), MFOLD (Zuker, Nucleic Acids Res. 2003; 31(13), 3406-15); EINVERTED (Rice, et al., Trends Genet. 2000; 16:276-277); PALINDROME; EQUICKTANDEM; VECSCREEN, and the like. In one aspect of the invention, the probe sequence and/or the complement of a nucleic acid probe sequence is evaluated. In another aspect of the invention, an amino acid sequence corresponding to a nucleic acid probe sequence is evaluated. In a further aspect, a DNA probe sequence is converted to an RNA sequence and evaluated. In still a further aspect, an RNA sequence is converted to a DNA sequence and evaluated. In one aspect, sequences are compared to motif sequences in a motif database. In another aspect, a sequence in a probe is compared to coding sequences, e.g., using a program such as COMBAT (Pedersen, et al., “Comparison of Coding DNA in Proceedings of the 9th Annual Symposium of Combinatorial Pattern Matching (CPM),” 1998). However, sequences also can be compared to non-coding sequences or to combinations thereof. In one aspect, an amino acid sequence corresponding to a probe request (e.g., encoded by a probe sequence or a complement thereof) is compared to sequences in an immunological database, such as AbCheck.

When a requested probe exceeds a predefined threshold identity to an unapproved sequence, a data flag is associated with the probe request. In one aspect, the system will notify a probe requester that the probe request is on hold, not approved, is subject to further approval, pending receipt of certain information (by the system or by individuals designated to the system for receiving the information), or is subject to approval subject to certain limitations (e.g., acceptance of certain contract terms, restrictions on use, etc.).

In some aspects, a certain number of data flags must be accumulated for a hold, for example a plurality of unapproved sequences must be requested to receive a hold. The plurality of data flags may indicate a relationship among the unapproved sequences (e.g., that the unapproved sequences represent a plurality of sequences from the genome of the same pathogenic organism) or may indicate that a predetermined threshold of unapproved sequences has been exceeded.

In certain aspects, the system may provide an output (e.g., on a display of a user device in communication with the system, in the form of an email to a designated email address provided to the system by the probe requester, or in the form of a report on a tangible medium) inviting the probe requester to withdraw or modify the probe request. In another aspect, the system will not accept further requests from the probe requester, unless the probe requester withdraws or modifies the probe request and/or acknowledges the hold, lack of approval and/or request for further information.

However, in other aspects, the data flag places a hold on a downstream step, such as synthesis of the probe and/or manufacturing of the array until one or more designated system users (“reviewer(s)”) review the request. Notice to the probe requester of the hold may occur at the same time, before, or after notice is provided (either sent to, received by or acted on by) to the reviewer(s). In one aspect, the probe requester receives notice of the data flag; however, in other aspects, the probe requester does not receive notice of the data flag. In certain aspects, notice is only provided if a negative decision is reached in evaluating the probe request. In still other aspects, notice to the user and/or to the one or more designated reviewers, includes remarks, e.g., such as a description of the reason for the data flag(s) and/or hold, lack of approval, and/or request for further information.

In certain aspects, the requested further information can be provided to the individual/entity designated for receipt of the information by any means of communication, e.g., by telephonic communication, by inputting the information into a user device in communication with the system, sending an email directly to an individual designated for receipt of the information, etc. The requested further information can be provided to the system processor directly by the user or by the individual/entity designated for receipt of the information. In certain aspects, the system responds to the requested further information by removing the hold, by indicating that the probe request is not approved, or that approval may be subject to limitations (e.g., restrictions on use). In still other aspects, when a probe request is associated with a data flag, the system may provide an ouput to the probe requester (e.g., in the form of a display on a user device, an email, a report, etc) (e.g., via the output manager), identifying one or more alternative probe sequences that would not be associated with a data flag. In certain aspects, the system may also provide the probe requester with data relating to one or more properties of alternative probes (e.g., nucleotide sequence, sequence of complementary strands, protein sequence, Tm's, functional data, etc.). In some aspects, the system provides check boxes, or links associated with the identifiers that provide the probe requestor with the option to select one or more of the alternative probe sequences for inclusion on the array.

In further aspects, where a set of probe sequences has received a data flag, the probe requester is provided the option to remove and/or modify one or more members of the set. In certain aspects, the system can display suggestions regarding sets of probe sequences that may be removed to remove the data flag, and optionally, identify one or more suggested alternative probes.

In one aspect, if a probe request with a data flag is approved (with or without prior notice to the probe requester), the probe request is provided to the output manager which communicates the probe request to an agent (e.g., such as a manufacturer and/or vendor) in the form of an order to synthesize or supply the probe, for example, immobilized on a solid substrate such as a microarray. In certain aspects, the data flag is removed from the probe request (e.g., the flagged probe request is deleted and a copy of the probe request, now unflagged is saved).

In other aspects, an audit trail of data flags and information relating to these data flags is generated and maintained, e.g., indicating one or more of: when a status (e.g., “hold,” “approved,” “not approved,” “further information requested”) was assigned; what the status was; the probe requester's response to a notice of a hold, lack of approval or request for information; the reviewer's response to a notice; when information was provided in response to a request for further information; what the information was; who provided the information; who was designated to receive the information; what the response to the further information was; who provided the response to the further information; the date on which the response was provided; any change in status; the date on which a change in status occurred; whether a requested probe was synthesized and/or made part of an array; the date on which the request probe was synthesized and/or made part of the array; the identity of an identifier (e.g., such as a bar code) associated with the synthesized probe and/or array; a date on which the probe and/or array was provided to the probe requester or an agent of the probe requester, whether restrictions on use where imposed, and the like. Additionally, various identifying characteristics of the probe requester may be stored in a memory of the system and/or associated with data flags associated with particular probes.

However, in another aspect, once a probe request is approved, data relating to the data flag may be removed from the system after a predetermined period of time, e.g., as determined by a system administrator.

In certain aspects, data flags are assigned to probes to control the use of probes that might be released from the array, e.g., such as probes that are cleaved from the array. For example, the data flags might be used to minimize the possibility that an array ordered for manufacture through the system might be used in a way that does not meet the approval of the system administrator, i.e., the system administrator may only desire to warrant the array for certain uses and therefore might choose to limit the possibility of other uses. In one aspect, a use that is proscribed in the use of probes released from the array for gene synthesis.

The processing module may include additional features for facilitating the development of chemical arrays including one or more of the requested probe molecules. In certain aspects, the processing module is configured to identify relationships between sequences of a requested probe molecule and data stored in a memory of the system. For example, in certain aspects, the processing module identifies relationships between sequences of probe molecules and/or other data structures corresponding to a probe request and one or more annotation categories. Further in certain aspects, data structures are associated with objects and the processing module is configured to identify relationships to one or more objects.

In one aspect of the invention, in response to a probe request and upon approval thereof, the output manager provides probe content and associated annotation information relating to one or more probe sequences that fit the user's request. In another aspect, the output manager ranks the plurality of probe sequences according to their fit.

In certain embodiments, the system associates a probe request with criteria for allowing the system to identify one or more probe sequences (i.e., a probe group) corresponding to the criteria. For example, the probe group members can belong to a common annotation category and the probe request, rather than specifically identifying a sequence or sequence identifier as part of the request, can include information that more generally identifies the annotation category. Thus, in one aspect, for example, a probe request can include a keyword such as “cancer” and inputting the probe request will cause the system to display a plurality of probes which are associated with this keyword in a database of the system or which the system can access.

In certain aspects, the probe group (which can include a single member) is displayed on the display of a user device. The display can include graphical representations of members of the probe group, e.g., probe members can be represented by identifiers or by symbols (e.g., which include information relating to an annotation category), or by other means. In certain aspects, the graphical representation of a probe member may be associated with a link to additional information relating to the probe member, e.g., such as a sequence information, links to published references, links to information about function of a larger sequence to which the probe sequence corresponds, and the like. In certain aspects, in response to a probe request including identifier information for a probe with a desired characteristic, the system can also display information for probes that might also be of interest to users with the same or different characteristics as the requested probes. For example, in one aspect, in response to a request for a low resolution probe, the system displays information relating to, or suggests probe group members which include high resolution probes, identifies a probe group of normalization probes for optional selection by the user, identifies spike-in probes, etc.

In one aspect, the output manager displays “probe content information” associated with a member of a probe group. Such information can include, but is not limited to: a probe sequence or an identifier associated therewith, and structural, functional genomic and/or proteomic information with respect to the probe sequence and/or identifier. In another aspect, probe content information includes relevant links or pointers to reagents or kits that might be used to obtain additional probe content information (e.g., such as links or pointers to sources of primers, antibodies, binding partners, and host cells, including transgenic animals expressing the sequences or modified forms there of, and the like). In other aspects, probe content information may include, but is not limited to, information regarding cell(s) or tissue(s) in which a probe sequence is expressed and/or levels of expression, information concerning physiological responses of a cell or tissue in which the sequence is expressed (e.g., whether the cell or tissue is from a patient with a disease), chromosomal location information, copy number information, information relating to similar sequences (e.g., homologous, paralogous or orthologous sequences). Additional probe content information can include frequency of the sequence in a population, information relating to polymorphic variants of the probe sequence (e.g., such as SNPs), information relating to splice variants (e.g., tissues, individuals in which such variants are expressed), and or demographic information relating to individual(s) in which the sequence is found.

A probe requester can select one or more members of the probe group for ordering, for inclusion in an array, for design of an array layout, etc. The selection can be provided to another user of the system, e.g., a manufacturer of arrays and/or a synthesizer of probes by a variety of means and/or a vendor (e.g., who interacts with the manufacturer and/or synthesizer), e.g., via an email from the probe requester, via a notice directly from the system, via transmission of a hard copy of the display selection, etc. In certain aspects, selection of a probe group and/or array layout comprising one or more probe groups is linked directly to an e-commerce site associated with the manufacturer. In one aspect, selection of the probe group and/or array layout is associated with a customer number associated with the probe requestor in a database of the system or accessible by the system, allowing charges to be associated with the request and a manufacturer order to be completed.

In certain embodiments, the output manager further provides a user with information regarding how to purchase at least one probe sequence. In certain embodiments, the information is provided in the form of an email. In certain embodiments, the information is provided in the form of web page content on a graphical user interface in communication with the output manager. In certain embodiments, the web page content includes fields for inputting customer information. In certain embodiments, the system can store the customer information in the memory. In certain embodiments, the customer information includes one or more purchase order numbers. In certain embodiments, the customer information includes one or more purchase order numbers and the system prompts a user to select a purchase order number prior to purchasing the one or more synthesized probe sequences.

In certain aspects, members of a probe group may be associated with a data flag. In one aspect, a user is provided with an option to select other members of the group, which are not associated with the data flag to complete the order. In another aspect, the system notifies a reviewer of the data flag and, optionally, provides a notice to the probe requester that the selection is being reviewed and the reviewer can, as if desired, modify the status of the probe group member(s) associated with the data flag (e.g., remove the hold, request further information, or refuse to provide probes associated with the data flag, or some combination of the above). However, in certain aspects, the reviewer can modify the probe group to remove probes associated with data flags from the probe group, allowing the probe requestor to view only those probes which are not associated with a data flag. In still a further aspect, the system automatically removes probes from the probe group list, which would otherwise be associated with a data flag.

In one certain aspects, a data flag associated with a probe group member is displayed on the probe requester's display and is accompanied by a request for further information (e.g., in the form of a message that appears on the display). The probe requester is invited to contact the person designated to receive the further information (who may also be the same or a different reviewer) to provide the further information. In certain aspects, if a probe selection is not modified to include only approved probes, a probe group selection may be refused.

However, in other aspects, the system may only display probe group members of a probe group not associated with a data flag. In certain aspects, members of a probe group associated with a data flag are apparent only to a reviewer who is notified of the selection. The reviewer may opt to release a hold associated with a data flag and in certain aspects, the system will update the probe group to include the additional probe group members, inviting the probe requester to select one or more or no additional probes for inclusion in the selected probe list.

It should be noted that one or more users of the system may have overlapping functions. For example, a reviewer may also be one or more of: a person designated to receive further information, a system administrator, and/or a manufacturer or other individual or entity receiving an order for a probe.

In certain aspects, versions of probe groups are stored in the memory of the system, and optionally, the system can include a means for providing an audit trail as versions change, e.g., identifying which user added or removed a probe member and/or changed the status of a probe in a version of a probe group and/or when the change occurred (or identifying when a new version was created in which probe members were added or removed or changed status and who created the new version).

In certain aspects, the system includes a difference engine for comparing at least two versions of the probe groups. In certain aspects, the output manager displays results of any comparing step to one or more users (e.g., such as reviewers).

One or more permitted users may have permission to modify different versions of probe groups. In certain aspects, users may have different sets of permissions. For example, a probe requester may have permission to modify a version or set of versions (e.g., such as versions which do not include probes indicated by data flags) but not other(s) or may have permission to modify selected portions of versions, e.g., such as probe members of probe groups which are not associated with data flags.

In embodiments, the systems include various functional elements that carry out certain probe development-specific tasks on the platforms in response to information introduced into the system by one or more users. In one aspect, processing modules can include at least one functional element that generates a probe, and particularly a sequence of a probe, e.g., for use in an array layout, where the functional element generates the probe based on probe request information received from one or more users. A feature of certain embodiments of the subject invention is that the system includes a processing module configured to identify a probe sequence that best fits a user's request, i.e., probe request information, based on information regarding attributes of a plurality of data structures, as described above. In another aspect, based on predefined system criteria established by the system administrator, the processing module is configured to identify a probe sequence that does not include criteria or characteristics that would otherwise cause the probe to be associated with a data flag.

This functional element of the processing module is conveniently referred to herein as a probe developer. The probe developer is configured to accept probe request information from a user and determine the sequence of a suitable probe based on the request information. The probe request information may vary depending on a given application, where representative types of probe request information include, but are not limited to: gene name or other identifier, annotation information, biological function information, target sequence information, etc.

In certain embodiments, the probe developer of the processing module is configured to provide validation information for a probe provided in response to received array probe request information from a user. In these embodiments, a user will input probe request information into the system, as described above. The probe developer may then return to the user one or more validated probes, where a probe is considered to be validated if it has been empirically tested and shown to function according to a predetermined set of functional criteria, e.g., the probe provides a suitable signal and suitable low background noise. In addition to returning to the user one or more validated probes, the probe developer may also make available to the user, e.g., for downloading, validation information for the probe, e.g., information regarding how the probe was validated, the results the probe gave in the validation assays to which it was subjected, and the like. Such validation information may be employed by the user in a number of different manners, e.g., to support results obtained using an array that includes the corresponding validated probe. Other aspects relating to probe development may be implemented as described in U.S. patent application Ser. No. 11/001,672, filed Nov. 30, 2004 the entirety of which is incorporated by reference herein.

In addition to being able to select probe members of a displayed probe group, in certain aspects, a user is provided selectable options relating to an array layout. For example, in certain aspects, the user can select a location of one or more features on the array. However, in other aspects, the location of the one or more features is automatically selected for the user by the system.

In one aspect, the processing module includes an array layout developer. In certain aspects, the array layout developer includes a memory having a plurality of rules relating to array layout design, where the array layout developer is configured to develop an array layout based on the application of one or more of the rules to information that includes array request information received from a user, which can include probe request information. In certain aspects, the output manager provides a version of an array layout to a user.

In one aspect, a layout rule comprises randomizing probe content on the array. In another aspect, a layout rule comprises randomizing selected probes (e.g., such as non-control probes) on an array. In a further aspect, a layout rule comprises randomizing probes, which can be selected probes, on certain areas (e.g., quadrants) on an array. In one aspect, layout rules include rules for identifying and/or positioning (e.g., relative to other probes and/or relative to locations on a substrate—such as distance from an edge, distance from another array, etc) control probes, validation probes, normalization probes, and the like. In another aspect, layout rules include rules for selecting array formats or other array layout parameters. In a further aspect, layout rules can include rules for designing arrays that have desired properties for particular array-based applications such as applications that require specific binding to target sequences. For example, the layout rules can include rules for identifying and/or positioning probe sequences which have a selected Tₘ or range of T_{m'}s or binding affinity that would be optimal for a desired application (such as in a gene expression assay, CGH assay, location analysis assay, etc.) and/or for identifying and/or positioning probe sequences which have a predicted level of binding partners in a target population. For example, the system can apply a rule that probes that correspond to targets that are expressed highly in a target population are positioned at one or more corners of the array or that probes having a selected range of T_{m'}s are placed in a selected quadrant of the array. Other aspects relating to array layout development may be implemented as described in U.S. patent application Ser. Nos. 11/000,681 and 11/001,700, both filed Nov. 30, 2004, the entireties of which are incorporated by reference herein.

In addition to providing notices to a probe requester, a reviewer, a person designated to receive further information about a probe request, a system administrator, a manufacture or other individual or entity receiving an order for a probe, or other users of the system (generically each referred to herein as “a user” of the system) regarding a hold or approval or a change in status of a probe request, in certain aspects, the output manager can provide notices to a user relating to system events, such as annotation updates, changes to the content of a probe group (one or more probe sequences satisfying the criteria of a probe request), changes to the content and/or layout of an array by other users with requisite permissions and the like.

As discussed above, in certain aspects, the system, e.g., via the output manager, can provide a probe requester with information regarding how to purchase one or more probe groups. In one aspect, the information is provided in the form of an email. In another aspect, the information is provided in the form of web page content on a graphical user interface in communication with the output manager. In certain aspects, the web page provides a user with an option to select for purchase one or more synthesized probe sequences. In one aspect, the web page content includes fields for inputting customer information.

In certain embodiments, the system stores customer information in the memory. Customer information can include one or more purchase order numbers, identifier information for a customer, shipping address, billing address and the like. In one aspect, the customer information includes one or more purchase order numbers and the system prompts a user to select a purchase order number prior to purchasing the one or more synthesized probe sequences.

In certain embodiments, in response to the ordering, the one or more probe sequences are synthesized on an array.

In certain embodiments, systems according to the invention, include, as discussed above: a communications module for facilitating information transfer between the system and one or more users, e.g., via a user computer, as described below; and a processing module for performing one or more tasks in response to information received via the communications module of the system. In one aspect, the systems include means for providing a “web portal” refers to a web site or service, e.g., which may be viewed in the form of a web page, that offers a broad array of resources and services to users via an electronic communication element, e.g., via the Internet.

In one aspect, systems include hardware and/or software components. For example, hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Sun Solaris, Linux, OS/400, Compaq Tru64 Unix, SGI IRIX, Siemens Reliant Unix, and others.

In certain embodiments, systems include multiple computer platforms which may provide for certain benefits, e.g., lower costs of deployment, database switching, or changes to enterprise applications, and/or more effective firewalls. Other configurations, however, are possible. For example, as is well known to those of ordinary skill in the relevant art, so-called two-tier or N-tier architectures are possible rather than the three-tier server-side component architecture represented by, for example, E. Roman, Mastering Enterprise JavaBeans™ and the Java™2 Platform (John Wiley & Sons, Inc., NY, 1999) and J. Schneider and R. Arora, Using Enterprise Java. (Que Corporation, Indianapolis, 1997).

Hardware and associated software or firmware components that may be implemented in a server-side architecture for Internet commerce are known and need not be reviewed in detail here. Components to implement one or more firewalls to protect data and applications, uninterruptable power supplies, LAN switches, web-server routing software, and many other components can be included as are known in the art. Similarly, a variety of computer components customarily included in server-class computing platforms, as well as other types of computers, will be understood to be encompassed within the scope of the invention. These components include, for example, processors, memory units, input/output devices, buses, and other components that can be incorporated in a user computer. Those of ordinary skill in the art will readily appreciate how these and other conventional components may be implemented.

Functional elements of system may also be implemented in accordance with a variety of software facilitators and platforms (although it is not precluded that some or all of the functions of system may also be implemented in hardware or firmware). Among the various commercial products available for implementing e-commerce web portals is BEA WebLogic from BEA Systems, which is a so-called “middleware” application. This and other middleware applications are sometimes referred to as “application servers,” but are not to be confused with application server hardware elements. The function of these middleware applications generally is to assist other software components (such as software for performing various functional elements) to share resources and coordinate activities. The goals include making it easier to write, maintain, and change the software components; to avoid data bottlenecks; and prevent or recover from system failures. Thus, these middleware applications may provide load-balancing, fail-over, and fault tolerance, all of which features will be appreciated by those of ordinary skill in the relevant art.

Other development products, such as the Java™2 platform from Sun Microsystems, Inc. may be employed in the system to provide suites of applications programming interfaces (API's) that, among other things, enhance the implementation of scalable and secure components. Various other software development approaches or architectures may be used to implement the functional elements of system and their interconnection, as will be appreciated by those of ordinary skill in the art.

In certain aspects, a system according to the invention includes a memory having a plurality of objects. Types of objects include, but are not limited to, core objects, common objects, application objects, and the like. Objects may include plain old java objects or “POJOs.” In one aspect, the system includes an object/relational mapping mechanism for mapping relationships between objects and data. Relationships can include one-to-one relationships, one-to-many relationships and/or many-to-many relationships. In certain aspects, the system provides a mechanism for connecting objects to data held in a database (e.g., such as a relational database). For example, a persistence layer may be included in the system. Object-relational mapping products used in the system can integrate object programming language capabilities with relational databases known in the art, such as those managed by Oracle, DB2, Sybase, and the like.

In one embodiment, to introduce a new object to the system memory, the properties of the object (including its data elements) and its relationship with other objects are identified. In one aspect, each object is mapped to a table in a system database and the relationship between objects maps to the relationships between different object tables. In another aspect, mapping files are created for objects; where such files may be generated manually or automatically by the system.

In another embodiment, objects are organized within the system according to domains. Domains can include, but are not limited to, provider domains (e.g., such as vendor domains) which may represent entities that provide some or all of the components required to fabricate and provide an array or components of an array (e.g., probes, probe groups, reagents, and the like) to a customer and customer domains, representing entities who desire one or more components of an array (e.g., probes, probe groups, and/or a completed array and/or complementary reagents for use in analyzing an array). The system may also include a root domain that does not belong to any particular organization (e.g., vendor or customer), but is considered as the “superuser” domain. Domains may further include sub-domains. For example, a vendor domain may include sub-domains corresponding to different product and service providers within the organization. In one aspect, a user in a higher domain may have a plurality of roles (e.g., set of privileges or permissions) and these may be applied in all lower subdomains. Generally, there will be a single superuser who belongs to the root domain who has unrestricted access to all domains and sub-domains in the system.

In one embodiment, the system memory includes a plurality of probe objects. In one aspect, a probe object comprises at least one data element corresponding to a probe sequence (e.g., nucleotide or amino acid sequence). Thus, Probe object 1 and Probe object 2 would represent different sequences. Different Probe objects may be associated with one or more different attributes including, but not limited to: a unique database ID to uniquely identify a probe; name for a probe; sequence of the probe; type of probe (e.g., control, catalog, validation probe); a flag to identify the probe source (e.g., from one user, such as a vendor, vs. another); annotation(s) associated with the probe (e.g., description associated with the probe for identification such as information about the gene from which the protein is derived, its function, encoded products, interactions, chromosomal location, location within a gene (e.g., exon, intron, exon-intron junction), location within a transcript); probe group(s) to which the probe belongs; other probes associated with the probe (e.g., validation probes associated with a probe); characteristics of a probe that would cause it to be associated with a data flag; probes identified which are associated with data flags; identifiers of customers; identifiers of customers requesting probes associated with data flags; the name/user id of a person who created the probe; date on which the probe was created; date on which the probe was last updated; information relating to changes in the status of probes (e.g., on hold (and optionally, the reason for the hold), approved, approval subject to provision of additional information) and the like. A probe object can have a many-to-many relationship with a probe group, which may comprise one or more probe objects and associated attributes.

Each probe object may be associated with an interface for creating, modifying, and updating probe attributes, allowing such attributes to be configurable by a user. In one aspect, each probe interface provides the system with the capability to retrieve a probe ID, probe name, and probe group name as well as any of the other attributes associated with a particular probe object. Other interfaces may include those necessary to implement an audit trail and/or appropriate privileges.

For example, one attribute that may be modified may include probe length. In one aspect, the length of the probe sequence can be between 25 nucleotides to about 150 nucleotides, or about 25 to about 60 nucleotides. A probe object will belong to one Domain and can be shared to other Domains.

In one embodiment, the system comprises one or more manager modules that can execute the functions of creating, updating, deleting, reading and copying objects. In one aspect, each of a plurality of application objects has a factory manager for executing these functions. In another aspect, the system includes a search engine to retrieve data for all objects present in the database relating to an object category and return a collection to the user. In a further aspect, the search engine is used to get and/or read an object associated with an object ID. The ID provides a unique database ID for the object. The search engine can select appropriate object categor(ies) that relate to a user query and determine appropriate mapping files to use and which database table to retrieve data from.

The system additionally may include a mechanism for updating objects provided by the search engine and identifying which mapping file to use and which database table to update the data into. In one aspect, updating includes deleting objects. The system additionally may include a mechanism for “deep copying” an object along with all of its reachable references (e.g., related objects). For example, if an array layout is copied then all of the objects associated with the array layout object will be copied as well.

The system may additionally include one or more probe object managers. In one aspect, a probe manager is a factory class for creating/copying/updating/finding/deleting probe objects. A user or users with requisite privileges is allowed to upload (hence, to create) a probe in the system using the one or more probe managers. Probe managers may be created by the system on the fly, e.g., for each new session in which a user interacts with the system.

As discussed above, the system may be used to organize probe objects into probe group objects.

In one embodiment, a probe group object encapsulates a list of probes grouped together based on some criteria. A probe group object has a many-to-many relationship with a probe object. A probe group object can belong to one domain and can be shared to other domains. A probe group can have zero or more annotations associated with it. A probe group having a zero annotation, for example, may include probe groups with unknown targets.

Like probe objects, probe group objects can be associated with attributes, including, but not limited to: probe group ID, probe group name, annotations associated with the probes in the probe group, annotation category to which the annotations belong, search criteria (e.g., the search criteria used by a user to generate the probe group), status (e.g., “locked” or “in progress”), the domain to which the probe group belongs, domain share (a set of domains to which the probe group object has been shared to), number of probes in the probe group, the ID of the user who created the probe group, the date on which the probe group was created, date on which the probe group was modified (and ID of the user who modified), information relating to changes in the status of a data flag associated with probe members of a probe group, and the like. Certain attributes may change over time (e.g., over sessions, as discussed further below). For example, “search criteria” is an example of a dynamic attribute that may change over time. Similarly, probe status relating to a data flag may change over time (e.g., when a reviewer approves availability of a probe on hold or for which further information has been requested).

The system may further include one or more probe group object managers for creating/updating/finding/deleting probe group objects. A user or users with requisite privileges will be allowed to create a probe group in the system.

As discussed above, annotations can be associated with a probe object and/or a probe group object. In one aspect, a particular annotation will only belong to one object (e.g., a probe object or probe group). A probe and probe group has one-to-many relationship with an annotation. In one aspect, annotations are updated and deleted by users with requisite permissions. In another aspect, annotation modifications (e.g., updates, deletions) are displayed in a report made available to a user of the system (e.g., via an email or an alert displayed on a Web page of a graphical user interface in communication with the system memory. In certain aspects, annotations may be ranked, e.g., according to whether an annotation is a primary or secondary annotation for a particular category. In one aspect, the annotation objects are hierarchically organized so that a user may search for a particular term in the hierarchy and the system, in response, can return one or more downstream terms as well as the term of interest. In one embodiment, the system uses annotations to search for probes, to form probe groups, to acquire the most recent annotations, and/or to create design files in pre-defined formats.

Annotation objects may be associated with one or more attributes, including, but not limited to, ID (a unique database ID used to uniquely identify an annotation), value (actual value of an annotation), category, a “container object reference” with which the annotation is associated (for example, a container can be a probe or a probe group), a flag to identify an annotation as a primary annotation, object type of the container with which the annotation is associated, and the like. In one aspect, the system includes an annotation manager for creating/updating/finding/deleting annotation objects. A user or users with requisite privileges will be allowed to create an Annotation in the system.

In one aspect, annotations are organized within the system by annotation category. Annotation categories may be hierarchical in nature. In certain aspects, annotation categories include, but are not limited to, the following categories: accessions (including, but not limited to RefSeq, GenBank, UniGene, customer, and the like), title line (e.g., customer 1, customer 2, etc.), gene ontology (GO) (e.g., including, but not limited to, molecular function, biological process, cellular component, and other biological characteristics associated with a gene), pathway (e.g., cell cycle, apoptosis, etc.), which may be linked (e.g., include pointers) to external database data (e.g., such as data found in BioCarta at IMGENEX, TRANSPATH—Signal Transduction Browser, Metabolic Pathways of Biochemistry, KEGG—Kyoto Encyclopedia of Genes and Genomes, Biochemical Pathways—presented by Boehringer Mannheim at ExPASy), cell/type tissue type in which the gene is expressed (e.g., heart, liver, T-cell, brain, etc), genomic category (e.g., intergenic region, binding site, repeat region, transcribed region), identifiers used in other databases, and the like. Annotation category objects may include audit trails and associated privileges. Further, annotation category objects also may have associated attributes such as ID, name, description, annotation source (e.g., an annotation source reference for a particular annotation category), datatype (e.g., string, URL, integer), parent annotation category (e.g., annotation upstream in a hierarchy of annotations).

In one embodiment, the system further includes an annotation category object manager for creating/updating/finding/deleting annotation category objects. A user or users with requisite privileges will be allowed to create an annotation category in the system.

As indicated above, in one aspect, the system further comprises a controller for communicating with a graphical user interface (e.g., to create first instances of objects in a memory of the system and to output displays that allow a user to interact with the system and obtain information about data elements associated with an object). The system may be deployable using any operating system known in the art, such as Windows XP. In one aspect, the system executes one or more programs that run on a Web server and build Web pages. In another aspect, the system is capable of building a Web page on the fly allowing the system to dynamically adapt to a user's requests. In still a further aspect, static HTML may be mixed with dynamically-generated HTML for this purpose. The system may include typical browsers known in the art such as Internet Explorer 4.0+ and Netscape Navigator 6.0+.

In certain embodiments, the system includes a search engine for responding to user queries (e.g., inputted into a graphical user interface in communication with the system). In one aspect, each persistent object in the system memory has an associated table in a system database and object attributes are mapped to table columns. In a further aspect, each object has an object relational mapping file which binds that object to the table in the database. Objects are also associated with each other and this association is mapped as the relation between the tables. Objects are also associated with each other by many different relationships, such as one-to-one, one-to-many, many-to-one and many-to-many. For example, consider a probe object and an annotation object. Where a probe has many annotations, the probe object thereof contains a collection of annotations. This structure is referred as a one-to-many relation and is mapped in the database with a foreign key field (person) in an Annotation table stored in the memory of the system.

Search criteria may include descriptions of attributes or properties associated with an object and/or by values corresponding to those attributes. Relationships may also be used as search criteria. Basic search criteria can depend upon an object's attributes and advanced search criteria can depend upon association of the object with other objects, e.g., by searching properties of related objects. For example, attributes associated with a probe object may include sequence, unique identifier, gene function, etc. The sequence may also be represented by a sequence object, which may include such attributes as function. So, the basic criteria for searching for a probe may be by sequence, while more advanced search criteria may include searching for a probe by interactions with other genes/gene products in a pathway.

In one embodiment, the search engine comprises a finder framework, which will construct a plurality of queryable conditions (e.g., all possible queryable conditions). When a user specifies an entity or object to search for, the framework generates all possible search conditions for that object and then gives the result as per the conditions selected by the user. A user of the system can search for probes, probe groups and/or array designs for different conditions. For example, a user can search for a probe that would fit into a certain annotation category. Search conditions may be different for different objects and in one aspect, a generic finder framework gives a generic solution for such searching.

In one aspect, after generating the conditions for searching, the finder framework localizes the names of attributes required for finding an object and displays the conditions to the user to specify the values for any number of conditions. Once the user specifies the search conditions with values, the framework executes the search and gets a collection of objects as result of search. In another aspect, the finder framework parses the mapping file of an object and all the other mapping files of its related objects to create simple and referential queryable conditions In certain embodiments, the search engine can build queries, save queries, modify queries, and/or update queries used to identify probes, probe groups, and/or array layout designs. In certain aspects, users with appropriate permissions can share, compare, modify and/or update queries. In certain other aspects, a user and/or the system can set the maximum output of a search and/or can rank search results according to fit to search criteria.

In response to a query, an output may be displayed by the system. For example, this output can include a list of values like Name, Creation Date, Status for the Probe Group object, which are retrieved as search result. These values are properties of the object under search or its associated object(s). In one aspect, the result to be shown is displayed on a Web page which includes capabilities for allowing possible actions. Such capabilities can include, but are not limited to, links, buttons, drop down menus, fields for receiving information from a user, and the like. In one aspect, for a probe group, such actions can include editing, comparing, etc. In certain aspects, the system further includes a result formatter for formatting search results (e.g., to build appropriate user interfaces such as Web pages, to specify links, provide a way to associate actions (e.g., “delete,” “edit,” etc.) with images, text, hyperlinks and/or other displays.

The system may also display the search criteria for an object under search on the web page. In one aspect, the system takes input data from the finder framework and creates a web page dynamically showing the search criteria for that object. In another aspect, the finder framework creates all possible queryable conditions for the object under search. These conditions are displayed on search web page as different fields. A user can select or specify value(s) for these field(s) and execute a search. The fields that are to be displayed have their labels in localized form. Fields may be in the form of a “select” box, or a text box or other area for inputting text. For example, a user may desire to search for a probe. A probe has queryable conditions that can include, but are not limited to, probe name, sequence number (e.g., accession number), and the domain (e.g., a vendor domain).

In one embodiment, the search engine supports searching for different objects such as probe, probe group, and/or array layout design. As indicated above, in one aspect, the system provides a generic finder framework to create all queryable conditions for an object under search. Such conditions will generally depend upon the properties of the object and its relationship(s) with other objects. In another aspect, the finder framework retrieves localized field names for these conditions and their order and stores these in the system memory (e.g., in an objectdefinition.xml file). In one aspect, fields are displayed on a search page in the order in which they are stored in a file as a set of search parameters for which a user can select or enter values. The search parameters may be in the form of a list of objects and the parameters may relate to attribute categories. For example, in response to a user searching for a probe group, the system may display the queryable conditions: “name of probe group,” “keywords used for search,” “domain,” “created by,” “modified by,” “modification date,” “annotation” and the like. The finder framework can return the queryable conditions in the form of a collection, which can be displayed on a search page, which lists or represents the various search fields corresponding to the attribute categories in a localized form. A user may enter values for these fields and perform, e.g., selecting one or more of a probe having a specific name, providing specific keywords, identifying a desired domain, creator, modification date, annotation, and the like. The system then displays a list of probe groups that satisfy the search conditions. In one aspect, the system displays information regarding the criteria used to perform the search.

In one aspect, the processing module further comprises a search engine for comparing probe request information content to data in the memory. In one aspect, the search engine executes a sequence alignment algorithm to identify sequences within data structures having predefined sequence identity to a reference sequence. Algorithms, include, but are not limited to, those employed by the programs blastp, blastn, blastx, tblastn and tblastx may be used (See. e.g., Karlin, et al., Proc. Natl. Acad. Sci. USA 87: 2264-2268 (1990); Altschul, S. F. J. Mol. Evol. 36: 290-300(1993); Altschul et al. (Nature Genetics 6: 119-129 (1994)). The search engine may search for literal or semantic matches to probe request information.

Search results can be shown on a web page, which may output a list of attributes associated with an object. For example, if a user is searching for Probe Group, the system may return a list of values like Name, Creation Date, Status of Probe Group objects, etc.

The web page may be a reusable component, and can be used for showing related objects for an object under consideration, searching for them and adding/removing them according to the search criteria used for object under consideration. In some cases, objects are searched by the attribute values of other objects related to the object under search. For example, in case of an array design search, a user can search array designs from the name of the probe group it contains. In certain aspects, a user is able to pick up the probe group names and add them to the search criteria of array design object. In one aspect, the system includes a “picker component” object for this selection purpose, which is a collection class for objects used for searching/associating an object with other objects.

In the above example, the following set of actions happen: first, the finder framework displays the search criteria for finding an array design. Since array design can be searched on the basis of probe group names, probe group name is one of the search criteria. It is a referential queryable condition for finding an array design. The finder framework will cause the system to display a link on the user interface, enabling a user to select a probe group and add its values for this referential queryable condition.

In one aspect, when a user clicks on the link “SEARCH”, the application initializes the picker component and since there are no Probe Groups selected for the referential queryable condition in the beginning, the collection of associated objects (e.g., probe group) in the picker component is empty. The system will then display a search page for the probe group. In another aspect, a user is provided with the ability to search for different probe groups, e.g., by their attributes (such as name, creation date, annotation, availability (e.g., absence of data flags) and the like) and results are displayed. In one aspect, the page provides both a description of the search criteria as well as a search result. In one aspect, the system may provide one display type for a probe requester and a different display type for a reviewer, e.g., revealing additional probes that might be available but which are associated with data flags based on criteria established by a system administrator. However, in other aspects, all users may be alerted of data flags associated with probe members of a probe group.

In one aspect, once a search for a probe group is completed, a user can select probe groups and add them to a collection of associated objects to be displayed. A user can select or remove the probe group from the associated objects collection “Picker Components object.” These associated objects are then added to the search criteria of array design when the user presses a “Done” button.

In one aspect, the Picker Component object includes methods for taking attributes associated with an object as an input parameter and adding the object to a collection of associated objects (e.g., objects which have relationships with the input object). The Picker Component can also remove an object from a collection of associated objects. In one aspect, the Picker Component repeats the process of collecting associated objects and retrieves appropriate information from each object. In another aspect, the Picker Component arranges the information in a tabular form, which may be displayed on a Web page or reported in another suitable format.

In certain aspects, results of a search query may be linked to option fields allowing a user to order items associated with an object. For example, a checkbox may be included next to a probe group to allow a user to add the probe group to a shopping cart or directly order the probe group. Similarly, selecting an array design may cause the system to display options to purchase the array design. In certain aspects, the system may display items associated with objects that have relationships to objects associated with items being purchased. For example, if a user selects a Probe Group 1 for purchase, the system would display one or more array layouts that have included Probe Group 1 and/or reagents (e.g., such as controls, probes, labeling reagents, amplification reagents) that other users who have selected Probe Group 1 have purchased or which otherwise may be of interest to the user.

In one embodiment, a user enters into a session with the system. A session represents a series of requests from a particular user to a particular application of the system over a certain period of time. In one aspect, the system maintains a memory of a session object's state(s). The system may rely on this information in processing a new request.

In another embodiment, the system comprises a mechanism by which an administrator of the system can monitor the number of users connected to the system at a particular time. In one aspect, an administrator can invalidate the session of any user at any time, so that the user would not be able to access the system. For example, if a user requests probes associated with data flags more than a predefined number of times (which may include one time), a system administrator may choose to block further access to the system. In certain aspects, the system may block a user from using the system until a user contacts a system administrator for renewed access.

A variety of interfaces may be used to implement the functions of the system. In one embodiment, in the case of web applications, a servlet container uses an HTTP Session interface to create a session between an HTTP client and an HTTP server. The session may persist for a specified time period, across more than one connection or page request from a user. In one aspect, one user may be involved in a session, and the user may visit the web application many times. However, multiple users also may be involved in a session. The server can maintain a session in many ways, such as by using cookies or rewriting URLs.

In another embodiment, the system comprises a session manager. The session manager acts as a factory class that may be used to generate objects, and in one aspect, related objects when a user interacts with the system. In another embodiment, information relating to all user sessions is maintained in a collection within the session manager. In a further embodiment, one session manager instance is associated with one application in the system. In still a further embodiment, session instances are associated with session manager instances. This structure ensures that there are collections of instances per application in the system.

The session manager may have one or more of the following properties. The session manager may comprise a collection of all Session objects for all current users using the system or an application of the system. In one aspect, the collection is in the form of a Hashtable.

In one embodiment, the system contains a plurality of different application objects. Application objects comprise object representations of underlying database tables. In one aspect, each application has a context associated with it. Context is a logical area of the application, which contains the configuration information for the application. This information can be accessed within that application via this context.

For example, in one embodiment, the system comprises an application bootstrap framework, which comprises a set of classes and a configuration file. In one aspect, the configuration file contains configuration information for each application. The application bootstrapping mechanism starts working when the system starts up for the first time. When system starts up, a system initialization program (e.g., start up Servlet) instantiates an instance of Application object per application in the system. The first request to the application server will check whether application context for the named application is there or not. If application context is not present then it creates one. In one aspect, the application bootstrap framework communicates with an object/relationship mapping means in the system, assisting a user to identify object categories associated with a user query. In another aspect, in response to the identification of object categories, an output (e.g., such as a display on a graphical user interface) is generated

In one embodiment, the system includes an event generation and processing framework. Whenever an action takes place on an object in the system, the system generates an event. The object that generates this event is called as the event source. In one aspect, when events occur, a user with requisite permissions is notified for these events. In certain aspects, to get an event notification, the user must register him/herself for that type of event. The user will get notifications only for those types of events for which the user has registered. For this, the system maintains a queue of the events, which contains only those events for which at least one user has registered. This queue is then processed periodically and notifications are sent to the users, e.g., by email. In one embodiment, the event notification framework generates events and adds them to the event queue, while the event processing framework processes the events from the event queue and then sends the notifications.

In one aspect, events supported by system application(s) are pre-configured. For example, the system memory can include a database of all supported (e.g., pre-configured events). In one aspect, the database includes a table comprising an event ID uniquely identifying a supported event (e.g., an annotation update), an action name for the event (e.g., “Annotation Update”), and name of an action that will be executed during post-processing of an event. The table may be a hashtable collection which may be associated with a particular user session by a session ID. In one aspect, the event manager allows a user to create, add and/or notify a user about events.

The Event Manager may include a mechanism for providing an output to a user which may include, but is not limited to the name of the event, an ID for an event uniquely identifying the event in the database, date of the event, content of an message to the user describing the event, type of event (e.g., triggered or periodic), and the like.

In certain aspects, a user may have an event manager associated with that particular user's events.

In a further aspect, the system comprises a Hashtable collection which contains a key-value pair of application name and session manager instance associated with an application. This collection is useful for identifying session manager instances for all applications in the system.

In one embodiment, a system according to the invention creates a session manager for an application if one did not already exist. In one aspect, the system may output data relating to all the session manager instances that are associated with the system (e.g., for all applications of the system). Similarly, the system may output information relating to the collection of session instances associated with any given session manager. The system may further remove a session from a session collection as well as invalidate a user session.

The system may further be configured to comprise a collaboration manager. In one aspect, the collaboration manager is configured to allow at least two different users to jointly provide array request information to an array layout developer.

In another aspect, the system further comprises a security manager configured to control information transfer in a predetermined manner between at least two different users or groups of users. For example, the security manager may control information that is communicated between members of a first group (such as a probe requester and probe reviewer and/or user designated to receive further information relating to a probe request and/or manufacturer or vendor capable of responding to probe selection to fill an order), or between a members of a second group (such as a probe reviewer and a person designated to receive further information and/or between a system administrator and/or manufacturer or vendor—where such communications may relate to maintaining a hold, or changing the status of a hold, etc). Communications between groups may be transparent or may be subject to controls such that one group is not aware of communications between members of the second group.

In a further aspect, the system comprises a vendor manager configured to provide access by a user to a service provided by at least one vendor. Functionalities that can be provided by the vendor manager are described in further detail in U.S. patent application Ser. No. 11/000,681, filed Nov. 30, 2004, the entirety of which is incorporated by reference herein.

In one embodiment, the system further includes an instructional module that executes instructions from a computer program product for displaying Web pages that instruct a user how to use and interact with the system to order probe groups and/or arrays and/or associated reagents. In one aspect, the instructional module provides a tutorial page, explaining the purpose of the module (e.g., to provide instructions for designing and/or ordering arrays, and/optionally, defining terms (e.g., probe groups, arrays, array layouts, annotations). Additional Web pages or sections of web pages can be provided to describe and provide examples of various system functions (e.g., such as searching, uploading probes, downloading probes, etc.) and can provide interactive sessions to illustrate system functions. Such sessions can include displaying information relating to searching for information about probes, identifying probes, uploading probes, downloading probes, demonstrating sorting, viewing, saving search results, providing tutorials for generating an array layout, and the like. The instructional module can include a variety of graphics, including text, images, animation and can also provide accompanying voiceovers.

As discussed above, in one aspect, the system's output manager provides information assembled by processing module, e.g., array layout and/or probe related content, to a user, e.g., over the Internet. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources.

Also, as discussed above, the communications module may be operatively connected to a user device such as a computer, which provides a vehicle for a user to interact with the system. A user computer may be a computing device specially designed and configured to support and execute any of a multitude of different applications. A user computer also may be any of a variety of types of general-purpose computers such as a personal computer, network server, workstation, or other computer platform now or later developed. Additionally, a user computer may be a wireless device, which can communicate with the network. The user device can include known components such as a processor, an operating system, a graphical user interface (GUI) controller, a system memory, memory storage devices, and input-output controllers. It will be understood by those skilled in the relevant art that there are many possible configurations of the components of computer and that some components are not listed above, such as cache memory, a data backup unit, and many other devices. The processor may be a commercially available processor such as a Pentium® processor made by Intel Corporation, a SPARC® processor made by Sun Microsystems, or it may be one of other processors that are or will become available.

The processor executes the operating system, which may be, for example, a Windows®-type operating system (such as Windows NT®4.0 with SP6a) from the Microsoft Corporation; a Unix® or Linux-type operating system available from many vendors; another or a future operating system; or some combination thereof. The operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

The system memory may be any of a variety of known or future memory storage devices. Examples include any commonly available random access memory (RAM), magnetic medium such as a resident hard disk or tape, an optical medium such as a read and write compact disc, or other memory storage device.

The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

The input-output controllers of the computer could include any of a variety of known devices for accepting and processing information from a user, whether a human or a machine, whether local or remote. Such devices may include, for example, modem cards, network interface cards, sound cards, or other types of controllers for any of a variety of known input devices. Output controllers of input-output controllers could include controllers for any of a variety of known display devices for presenting information to a user, whether a human or a machine, whether local or remote. If one of the display devices provides visual information, this information typically may be logically and/or physically organized as an array of picture elements, sometimes referred to as pixels.

A graphical user interface (GUI) controller may comprise any of a variety of known or future software programs for providing graphical input and output interfaces between the computer and a user, and for processing user inputs. In one aspect, the system may include a plurality of graphical user interfaces for viewing and manipulating multiple sets of data. In another aspect, the system will automatically provide modified information (e.g., such as new versions of a probe group, data relating to changes in the status of a data flag, etc.) to other permitted users of the system. The functional elements of the computer may communicate with each other via system bus. Some of these communications may be accomplished in alternative embodiments using network or other types of remote communications.

The invention further relates to a computer readable storage medium having a computer program stored thereon. The computer program, when loaded onto a computer, operates the computer to:

(a) receive probe request information; and

(b) determine whether a data flag should be associated with a requested probe.

In certain embodiments, the computer program further operates the computer to output probe information for the probe request, e.g., such as a probe sequence associated with the probe request and/or information as to whether the probe may be selected or is associated with a data flag.

In one aspect, the computer program executes a program for identifying a probe group based on a probe request. In certain aspects, identifying is based on information regarding attributes of data structures organized according to annotation categories, wherein each data structure comprises a plurality of data elements including probe sequence information. In another embodiment, the invention also provides an online service that provides users with the ability to perform one or more of the following: identify probe groups; create chemical array layouts (e.g., such as DNA array layouts); and run search queries against a database of probe sequences, probe groups, and/or chemical arrays. In one aspect, the invention provides a system that allows users to search for desired results, save the results, compare and contrast different search results, customize their own probe groups and/or array designs, download data, and order stock (e.g., catalog) or custom arrays directly from a vendor user of the system, and have access, subject to appropriate permissions, to portions of the system memory and database(s).

In some aspects, a computer program product comprises a computer usable medium having control logic (computer software program, including program code) stored therein. The control logic, when executed by the processor, causes the processor to perform functions described herein. In other embodiments, some functions are implemented primarily in hardware using, for example, a hardware state machine. Implementation of a hardware state machine so as to perform the functions described herein will be apparent to those skilled in the relevant arts.

The invention also provides programming, e.g., in the form of computer program products, for use in practicing methods of using the system. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture that includes a recording of the present programming/algorithms for carrying out the above described methodology.

As discussed above, in one aspect, a probe requestor (or permitted collaborator) can request selected probes which are not associated with a data flag and can chose to obtain an array having the requested probe content. For example, the requested probes can be included in an array layout and the array can then be fabricated according to the array layout. In certain aspects, a probe requestor (or permitted collaborator) can specify the location of the probe in the array layout. Specifying may include choosing a particular location in a given layout, or choosing from a section of system—provided array layout options in which the probe is present at various locations. Array fabrication according to an array layout can be accomplished in a number of different ways. For example, nucleic acid arrays in which the immobilized nucleic acids are covalently attached to the substrate surface, such arrays may be synthesized via in situ synthesis in which the nucleic acid is grown on the surface of the substrate in a step-wise fashion and via deposition of a presynthesized nucleic acid/cDNA fragment, etc., onto the surface of the array.

Where the in situ synthesis approach is employed, conventional phosphoramidite synthesis protocols are typically used. In phosphoramidite synthesis protocols, the 3′-hydroxyl group of an initial 5′-protected nucleoside is first covalently attached to the polymer support, e.g., a planar substrate surface. Synthesis of the nucleic acid then proceeds by deprotection of the 5′-hydroxyl group of the attached nucleoside, followed by coupling of an incoming nucleoside-3′-phosphoramidite to the deprotected 5′ hydroxyl group (5′-OH). The resulting phosphite triester is finally oxidized to a phosphotriester to complete the internucleotide bond. The steps of deprotection, coupling and oxidation are repeated until a nucleic acid of the desired length and sequence is obtained. Optionally, a capping reaction may be used after the coupling and/or after the oxidation to inactivate the growing DNA chains that failed in the previous coupling step, thereby avoiding the synthesis of inaccurate sequences.

In the synthesis of nucleic acids on the surface of a substrate, reactive deoxynucleoside phosphoramidites are successively applied, in molecular amounts exceeding the molecular amounts of target hydroxyl groups of the substrate or growing oligonucleotide polymers, to specific cells of the high-density array, where they chemically bond to the target hydroxyl groups. Then, unreacted deoxynucleoside phosphoramidites from multiple cells of the high-density array are washed away, oxidation of the phosphite bonds joining the newly added deoxynucleosides to the growing oligonucleotide polymers to form phosphate bonds is carried out, and unreacted hydroxyl groups of the substrate or growing oligonucleotide polymers are chemically capped to prevent them from reacting with subsequently applied deoxynucleoside phosphoramidites. Optionally, the capping reaction may be done prior to oxidation.

In yet other embodiments, the system may be in communication with an array fabrication station, e.g., where the system operator is also an array vendor, such that the user may order an array directly through the system. In response to receiving an order from the user, subject to approval by the system (which may be automatic, where no data flags are associated with requested probes or which may require further input by a reviewer, etc.), the system will forward the array layout to a fabrication station, and the fabrication station will fabricate the array according to the forwarded array layout.

Arrays can be fabricated using drop deposition from pulsejets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, light directed fabrication methods may be used, as are known in the art. Interfeature areas need not be present particularly when the arrays are made by light directed synthesis protocols.

Following array fabrication, the fabricated array may then be forwarded, i.e., shipped, to the user using any convenient means. As such, following fabrication, one or more array units may then be forwarded to one or more remote customer stations.

Chemical arrays having probes generated by the subject systems and methods find use in a variety of different applications, where such applications are generally analyte detection applications in which the presence of a particular analyte in a given sample is detected at least qualitatively, if not quantitatively. Protocols for carrying out such assays are well known to those of skill in the art and need not be described in great detail here. Generally, the sample suspected of comprising the analyte of interest is contacted with an array produced according to the subject methods under conditions sufficient for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; CGH assays, location analysis assays, nucleic acid sequencing assays, and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; 6,180,351. In certain embodiments, the subject methods include a step of transmitting data from at least one of the detecting and deriving steps, as described above, to a remote location.

In one aspect, in using an array made by methods of the present invention, the array can be exposed to a sample (for example, a fluorescently labeled analyte, e.g., a nucleic acid-containing sample) and the array is then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

All patents, patent applications, PCT applications and references disclosed herein are incorporated by reference herein in their entireties.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A system comprising:
an input manager for receiving probe request information from a probe requester; and
a processing module configured to identify a probe sequence associated with the probe request information, wherein the processing module associates a flag with one or more nucleic acid sequences corresponding to the probe request associated with a predefined sequence characteristic.

2. The system of claim 1, wherein the system provides a notice to a probe reviewer that a flag has been associated with a probe request.

3. The system of claim 2, wherein the notice also is sent to the probe requester.

4. The system of claim 1, wherein the characteristic is selected from the group consisting of: a cleavage site, a sequence forming secondary structure, a sequence providing a recognition site for a recombinase, a palindromic sequence, complementary sequences within a probe, a predefined primer binding site, a sequence type repeated in other probes being requested by the user, a vector sequence, a sequence with a predefined level of homology to a predefined sequence, and combinations thereof.

5. The system of claim 3, wherein the cleavage site is a restriction enzyme site.

6. The system of claim 4, wherein the predefined sequence is a sequence from a pathogenic organism.

7. The system of claim 3, wherein the notice includes a request for further information about the probe request.

8. The system of claim 2, wherein the system further comprises an output manager for providing probe content information to the probe reviewer.

9. The system of claim 8, wherein the output manager provides probe content information to the probe requester.

10. The system of claim 2, where the output manager further includes a communication module for communicating the probe content information to a vendor and/or manufacturer of nucleic acid sequences and/or arrays.

11. The system of claim 1, wherein the probe request includes selection criterium for identifying a probe.

12. The system of claim 1, where the probe request includes information selected from the group consisting of a sequence, a sequence identifier, an accession number, an exon identifier; a chromosomal location, information relating to an annotation category and combinations thereof.

13. The system of claim 10, wherein the probe request includes selection criterium and in response to the selection criterium, the output manager displays a probe group comprising probe content information for one or more probes.

14. The system of claim 13, wherein the output manager displays to the probe requester a probe group that does not include probe content information for a flagged probe sequence.

15. The system of claim 10, wherein the output manager displays to the probe requester a probe group that includes probe content information for a flagged probe sequence and information indicating that the probe is associated with a flag.

16. The system of claim 14, wherein the output manager displays to the probe reviewer a probe group that does include probe content information for a flagged probe sequence.

17. The system of claim 13, wherein a displayed member of the probe group includes a means for selecting the member for ordering, and wherein in response to the selecting, a notice is sent to a user of the system that the member of the probe group has been ordered.

18. The system of claim 14, wherein a displayed member of the probe group includes a means for selecting the member for ordering, and wherein in response to the selecting, a notice is sent to a user of the system that the member of the probe group has been ordered.

19. The system of claim 15, wherein displayed members of the probe group include a means for selecting individual members of the probe group for ordering, except for a member which is associated with a flag, and wherein in response to the selecting, a notice is sent to a user of the system that the member of the probe group has been ordered.

20. The system of claim 19, wherein, the flag can be removed from the probe member by a probe reviewer.

21. The system of claim 14, wherein the probe group displayed to the probe requestor is modifiable by a probe reviewer.

22. The system of claim 1, wherein the system comprises or can access a memory comprising a database of sequences having the predefined sequence characteristic.

23. The system of claim 22, wherein the system further comprises a search engine for comparing probe request information to data in the memory.

24. The system of claim 22, wherein the processing module determines whether a sequence being requested has a predefined threshold identity to a sequence having the predefined characteristic and associates a flag with the sequence being requested when the predefined threshold is met.

25. The system of claim 22, wherein the system adds a sequence corresponding to a probe request to the database for comparison with subsequent probe request sequences.

26. The system of claim 1, wherein a sequence corresponding to a probe request is associated with a customer identifier.

27. The system of claim 3, wherein the notice indicates a probe request status selected from the group consisting of: on hold; not approved; subject to approval pending receipt of information; and subject to approval subject to limitations.

28. The system of claim 27, wherein the limitations comprise acceptance of certain contract terms or restrictions on use.

29. The system of claim 3, wherein the system provides an output to the probe requester, inviting the probe requester to withdraw or modify the probe request.

30. The system of claim 29, wherein the system will not accept further requests from the probe requestor unless the probe requester withdraws or modifies the probe request and/or acknowledges the probe request status.

31. The system of claim 3, wherein notice of the flag is provided to the probe requester only if a negative decision relating to the probe request is reached by the probe reviewer.

32. The system of claim 3, wherein the notice includes a description of a reason for the flag.

33. The system of claim 1, wherein when a probe request sequence is associated with a flag, the system provides an output to the probe requester identifying one or more alternative probe sequences that would not be associated with a flag.

34. The system of claim 33, wherein the system additionally outputs data relating to a property of the one or more alternative probe sequences.

35. The system of claim 1, wherein where a set of probe sequences has received a flag, the probe requester is provided the option to remove and/or modify one or more members of the set.

36. The system of claim 8, wherein if a probe request with a flag is approved, the output manager communicates the probe request in the form of an order to synthesize or supply the probe.

37. The system of claim 36, wherein the order includes instructions to include the probe on an array.

38. The system of claim 1, wherein the system further provides an audit trail relating to a flag.

39. The system of claim 10, wherein the output manager communicates with a user device to display a selectable option relating to an array layout.

40. The system of claim 1, wherein the system further includes an array layout developer.

41. The system of claim 1, wherein a first probe request sequence is compared to a second probe request sequence and the predefined sequence characteristic comprises a relationship between the first and second probe request sequence.

42. The system of claim 41, wherein the relationship comprises sequence complementarity.

43. The system of claim 1, wherein the system further comprises a collaboration manager configured to all at least two different probe requestors to jointly provide probe request information and/or array request information to the system.

44. The system of claim 1, wherein the system further comprises a security manager configured to control information transfer in a predetermined manner between at least two different users or groups of users of the system.

45. A computer readable storage medium having a computer program stored thereon, wherein the computer program when loaded onto a computer operates the computer to receive probe request information and determine whether a flag should be associated with the requested probe.

46. A method comprising:
receiving probe request information;
identifying a probe sequence associated with the probe request information;
associating a flag with a sequence corresponding the probe request when the sequence is associated with a predefined sequence characteristic.

47. The method of claim 46, wherein a notice is provided to a probe reviewer that a flag is associated with a sequence corresponding to the probe request.

48. The method of claim 46, wherein the notice is sent to a probe requestor who has provided the probe request information.

49. The method of claim 47, wherein the notice also is sent to a probe requester who has provided the probe request information.

50. The method of claim 46, wherein the characteristic is selected from the group consisting of: a cleavage site, a sequence forming secondary structure, a sequence providing a recognition site for a recombinase, a palindromic sequence, a predefined primer binding site, complementary sequences within a probe, a sequence type repeated in other probes being requested by the user, a vector sequence, a sequence with a predefined level of homology to a predefined sequence, and combinations thereof.

51. The method of claim 3, wherein the cleavage site is a restriction enzyme site.

52. The method of claim 50, wherein the predefined sequence is a sequence from a pathogenic organism.

53. The method of claim 48, wherein the notice includes a request for further information about the probe request.

54. The method of claim 47, wherein the flag is removed from the sequence corresponding to the probe request.

55. The method of claim 47, wherein in response to the notice, a request for further information is sent to a probe requester who requested the probe.

56. The method of claim 55, wherein in response to received information from the probe requester, the flag is removed from the sequence corresponding to the probe request.

57. The method of claim 54, wherein an order for a nucleic acid comprising the sequence or for an array including the sequence is provided to a vendor and/or manufacturer.

58. The method of claim 46, wherein the probe request includes selection criterium for identifying a probe.

59. The method of claim 1, where the probe request includes information selected from the group consisting of a sequence, a sequence identifier, an accession number, an exon identifier; a chromosomal location, information relating to an annotation category and combinations thereof.

60. The method of claim 58, wherein in response to the selection criterium, a probe requester is provided with probe content information for one or more probes in a probe group.

61. The method of claim 60, wherein the probe content information does not include probe content information for a flagged probe sequence.

62. The method of claim 58, wherein the probe content information does include probe content information for a flagged probe sequence.

63. The method of claim 61, wherein probe content information is provided to a probe reviewer, which does include probe content information for a flagged probe sequence.

64. The method of claim 60, the probe requestor is provided with a means for selecting a member of the probe group for ordering.

65. The method of claim 64, wherein if a member of the probe group is ordered a notice is sent.

66. The method of claim 65, wherein the notice is sent to a vendor and/or manufacturer of nucleic acid sequences and/or arrays.

67. The method of claim 64, wherein the probe requestor cannot select a member of a probe group for ordering if the member is associated with a flag.

68. The method of claim 60, wherein a probe reviewer modifies probe information content for one or more members of the probe group.

69. The method of claim 46, wherein sequence corresponding the probe request is compared to a database of sequences having the predefined sequence characteristic.

70. The method of claim 69, further comprising determining whether a sequence corresponding to the probe request has a predefined threshold identity to a sequence having the predefined characteristic and associating a flag with the sequence when the predefined threshold is met.

71. The method of claim 48, wherein the notice indicates that a probe request has received a status selected from the group consisting of: on hold; not approved;
subject to approval pending receipt of information; and subject to approval subject to limitations.

72. The method of claim 71, wherein the limitations comprise acceptance of certain contract terms or restrictions on use.

73. The method of claim 48, wherein the probe requester is invited to withdraw or modify the probe request.

74. The method of claim 49, wherein notice of the flag is provided to the probe requester only if a negative decision relating to the probe request is reached by the probe reviewer.

75. The method of claim 48, wherein the notice includes a description of a reason for the flag.

76. The method of claim 48, wherein when a probe request sequence is associated with a flag, an output is provided to the probe requester identifying one or more alternative probe sequences that would not be associated with a data flag.

77. The method of claim 76, wherein the output further includes data relating to a property of the one or more alternative probe sequences.

78. The method of claim 46, wherein if the probe reviewer approves the probe request, an order is sent to a vendor and/or manufacturer of nucleic acid sequences and/or arrays to synthesize or supply the probe.

79. The method of claim 78, wherein the probe is synthesized or supplied on an array substrate.

80. The method of claim 46, further comprising designing an array layout or selecting an array layout for an array that includes the probe.

81. The method of claim 46, wherein a first probe request sequence is compared to a second probe request sequence and the predefined sequence characteristic comprises a relationship between the first and second probe request sequence.

82. The method of claim 81, wherein the relationship comprises sequence complementarity.

83. A computer program product comprising a computer readable storage medium having a computer program stored thereon for performing a method of claim 1.
